(19) United States
(12) Patent Application Publication
(10) Pub. No.: US 2011/0004839 A1
(43) Pub. Date: Jan. 6, 2011

(54) USER-CUSTOMIZED COMPUTER DISPLAY METHOD

(76) Inventors: Derek Cha, Tustin, CA (US); Kenneth Randall, Anaheim, CA (US); Liem Thanh Nguyen, Westminster, CA (US)

Correspondence Address: Jonathan A. Platt;Renner, Otto, Boisselle & Sklar, LLP, 19th Floor, 1621 Euclid Ave, Cleveland, OH, 44115, US

(21) Appl. No.: 12/828,559

(22) Filed: Jul. 1, 2010

Related U.S. Application Data
(60) Provisional application No. 61/222,553, filed on Jul. 2, 2009.

(51) Int. Cl. G06F 3/048

(52) U.S. Cl. 715/765

(57) ABSTRACT

A user-customized computer display method allows a user to interactively populate a template to produce a layout that may later be used as a desktop for display on a computer system. The user is able to select a template from a series of templates that may be represented as thumbnail images, and populate the template with content items, such as programs, documents, and/or urls, thereby producing a layout. A template design tool may be used to produce custom template configurations. The user may select a layout from the same thumbnail screen that allows selection of templates for population or re-population. The method may also allow association of layouts with monitor configuration, and simple and intuitive configuration of multi-monitor systems.

This application claims priority under 35 USC 119 from U.S. Provisional Patent Application No. 61/222,553, filed Jul. 2, 2009, which is incorporated by reference in its entirety.

### BACKGROUND OF THE INVENTION

1. Field of the Invention

The invention is in the general field of user-customized computer displays.

2. Description of the Related Art

U.S. Pat. No. 5,917,483 describes an advanced windows management system in which a user can make customizable “target windows” from frame windows each running a program. Labels may be associated with the target windows, and customized target windows may be saved and recalled.

U.S. Pat. No. 5,349,658 describes associating document images or screen views of programs with documents or programs, for reference in selection from a graphical user interface (GUI).

U.S. Patent Publication No. 2006/0132473 discloses associating monitor configurations with monitors that have been previously connected to a system.

In general, several virtual desktop management programs are known. Such programs allow a user to customize to one degree or another a virtual desktop.

Still there is room for improvement in the field user-customized computer displays.

### SUMMARY OF THE INVENTION

According to an aspect of the invention, a method of generating user-customized display configurations (layouts) in a computer system includes the steps of: providing a user with multiple populatable templates; receiving user input to populate at least some of the templates with content items to be run in panes of the templates; and saving the populated user templates for later use as a layout configuration used to produce a display on a monitor.

According to another aspect of the invention, a method of displaying a layout on a computer system includes the steps of: saving one or more user-configured display layouts, wherein the display layouts each include one or more panes associated with respective content items to be run in the one or more panes; automatically selecting one of the user-configured layouts; and displaying, on a display of the computer system (or attached to the computer system), the desktop associated with the selected display layout.

According to still another aspect of the invention, a method of generating user-customized display configurations in a computer system includes the steps of: selecting, by a user, of one or more templates from a plurality of templates; and receiving user input to populate at least one of the templates with one or more content items, to thereby create one or more layouts that may be used to create one or more desktops.

According to a further aspect of the invention, a method of displaying a layout on a computer system includes the steps of: saving one or more user-configured display layouts, wherein the display layouts each include one or more panes associated with respective content items to be loaded in the one or more panes; automatically selecting one of the user-configured layouts; and displaying, on a display of the computer system (or attached to the computer system), a desktop associated with the selected display layout.

According to a still further aspect of the invention, a method of generating user-customized display configurations in a computer system includes the steps of: displaying a plurality of thumbnail images on a computer screen, wherein the thumbnail images represent templates and/or layouts; and allowing user selection of one of the thumbnail images to perform a computer operation related to the template or layout associated with the selected one of the thumbnail images.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

Annexed are drawings depicting one or more embodiments of the invention. The drawings are not necessarily to scale.

FIG. 1 is a schematic view of a computer system that may be used in the present invention.

FIG. 2 is a screenshot of a display on the computer system of FIG. 1.

FIG. 3 is a screenshot showing populatable templates according to an embodiment of the present invention.

FIG. 4 is a screenshot showing the templates of FIG. 3, populated as layouts.

FIG. 5 is a high-level flowchart showing a method of making a customized display, in accordance with an embodiment of the present invention.

FIG. 6 is a flowchart showing a more detailed view of a first part of the method of FIG. 5.

FIG. 7 is a flowchart showing a more detailed view of a second part of the method of FIG. 5.

FIG. 8 is a flowchart showing a more detailed view of a third part of the method of FIG. 5.

FIG. 9 is a screenshot showing blank thumbnails.

FIG. 10 is a screenshot showing a series of unpopulated templates.

FIG. 11 is a screenshot showing a series of unpopulated templates, one of which is shown with a control bar.

FIG. 12 shows a variant of the screenshot of FIG. 11, with a two-pane template of FIG. 11 replaced with a four-pane template.

FIG. 13 is a flowchart showing a method of using a template design tool in accordance with an embodiment of the present invention.

FIG. 14 is a schematic representation of the template design tool.

FIG. 15 is a screenshot showing examples of templates that may be configured with the design tool of FIG. 14.

FIG. 16 is a screenshot showing an extended template.

FIG. 17 is an illustration of a list tool used to populate templates, with a list of programs in the foreground.

FIG. 18 is an illustration of the list tool of FIG. 17, with a list of documents in the foreground.

FIG. 19 is a screenshot of populatable templates in accordance with another embodiment of the present invention.

FIG. 20 is a screenshot of layout thumbnails in accordance with still another embodiment of the invention.

FIG. 21 is a screenshot showing thumbnail layouts with a combination of presentation configurations.

FIG. 22 shows a screenshot that is a first view of a monitor sync interface in accordance with an embodiment of the invention.

FIG. 23 shows a screenshot that is a second view of a monitor sync interface in accordance with an embodiment of the invention.

FIG. 24 is a flowchart showing steps of using a monitor sync interface.

FIG. 25 is a first view of the monitor sync interface.

FIG. 26 is a second view of the monitor sync interface.

FIG. 27 is a third view of the monitor sync interface.

FIG. 28 is a fourth view of the monitor sync interface.

### DETAILED DESCRIPTION

A user-customized computer display method allows a user to interactively populate a template to produce a layout that may later be used as a desktop for display on a computer system. The user is able to select a template from a series of templates that may be represented as thumbnail images, and populate the template with content items, such as programs, documents, and/or urls, thereby producing a layout. A template design tool may be used to produce custom template configurations. The user may select a layout from the same thumbnail screen that allows selection of templates for population or re-population. The method may also allow association of layouts with monitor configuration, and simple and intuitive configuration of multi-monitor systems.

What follows in the next several paragraphs are definitions of certain terms used in the application.

Desktop—a displayed environment on a monitor, preferably extending across substantially the entire screen

Panes (and Windows)—Both templates and layouts (defined below) can be considered windows that are divided into one or more pane; typically, panes are rectangular sub-regions of a rectangular template or layout. In addition, templates and Layouts can be considered virtual desktops in a windows based operating system, and in this case the panes represent windows arranged within the desktop. In the principal illustrated embodiments described below, panes are tiled (i.e. arranged without separating space), but the invention also encompasses the possibility of panes that are separated from each other within a desktop or window, or that overlap within a desktop or window (cascade windows).

Templates—Graphical depiction of the physical arrangement of one or more panes (in the illustrated embodiment, one, two, three or four panes). Templates show the user the potential configuration of one or more programs, documents and/or uniform resource locators (urls) within a desktop. Templates are precursors to layouts, which in turn are precursors to desktops. The panes of a template can be shown with a uniform background pattern separated by borders, or can have different background appearances e.g. different coloreds, or in one case discussed below, numbered areas.

Layouts (also referred to as “desktop layouts,” “desktop configurations,” or merely “configurations”)—After the user populates programs, documents or urls into each of the panes of a template, the method of the invention generates a Layout. A layout is an operating system object that depicts the location, size, and start-up content items of each window of a desktop in a thumbnail view. Preferably the content items may include programs, user documents, and favorite urls and may be depicted in the layout via scaled down view of the desktop; icons (e.g. program icons); file names or url names, or other user assigned names.

Thumbnails, Thumbnail view—The templates and the layouts resulting from templates, are arranged in a template screen that displays multiple thumbnails. Various illustrated embodiments show either four or six thumbnails in a 2×2 or 2×3 array. The thumbnail view provides a convenient user interface for users to retrieve saved templates and layouts, select thumbnails, modify or create new thumbnails. Selecting a template thumbnail activates the panes of the template to permit the user to populate content and create a layout. Selecting a desktop layout opens up the desktop in full screen view, while starting up the associated content items (programs, documents, and urls).

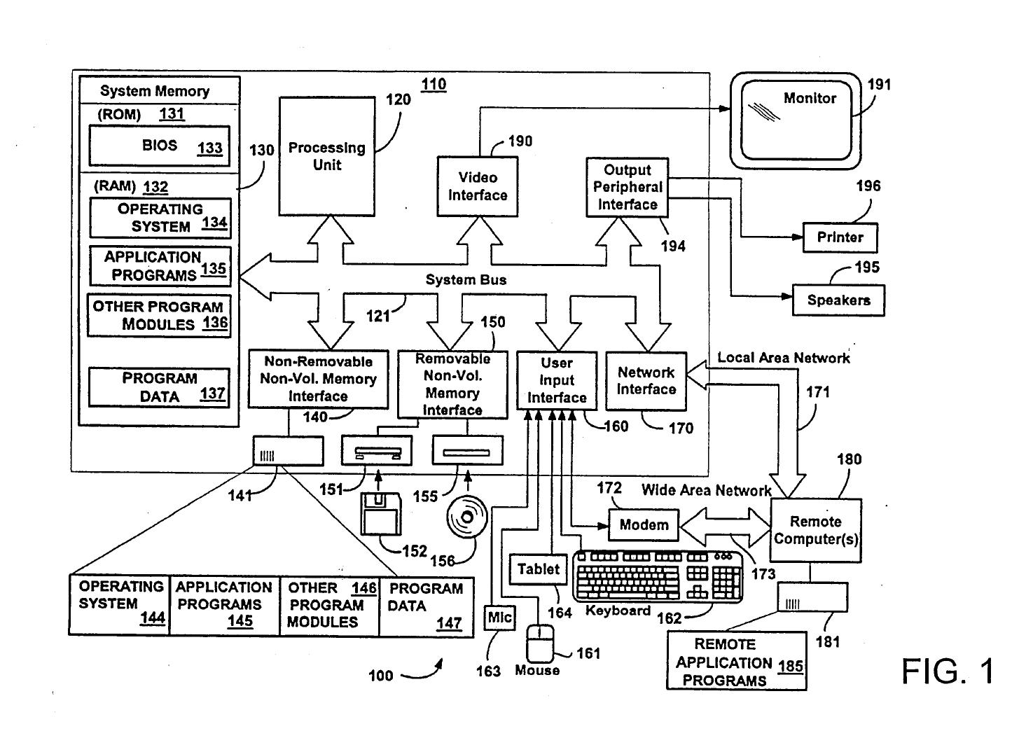

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics such as digital televisions, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Note that as described below, the present invention may involve towards data sources, which may, for example, include data sources corresponding to a SQL server and/or XML data provider (web service), that reside on one or multiple remote systems. The computing environment 100 of FIG. 1 is understood to include any local and/or remote source of data, including the SQL server-provided data, web service server provided data, and others.

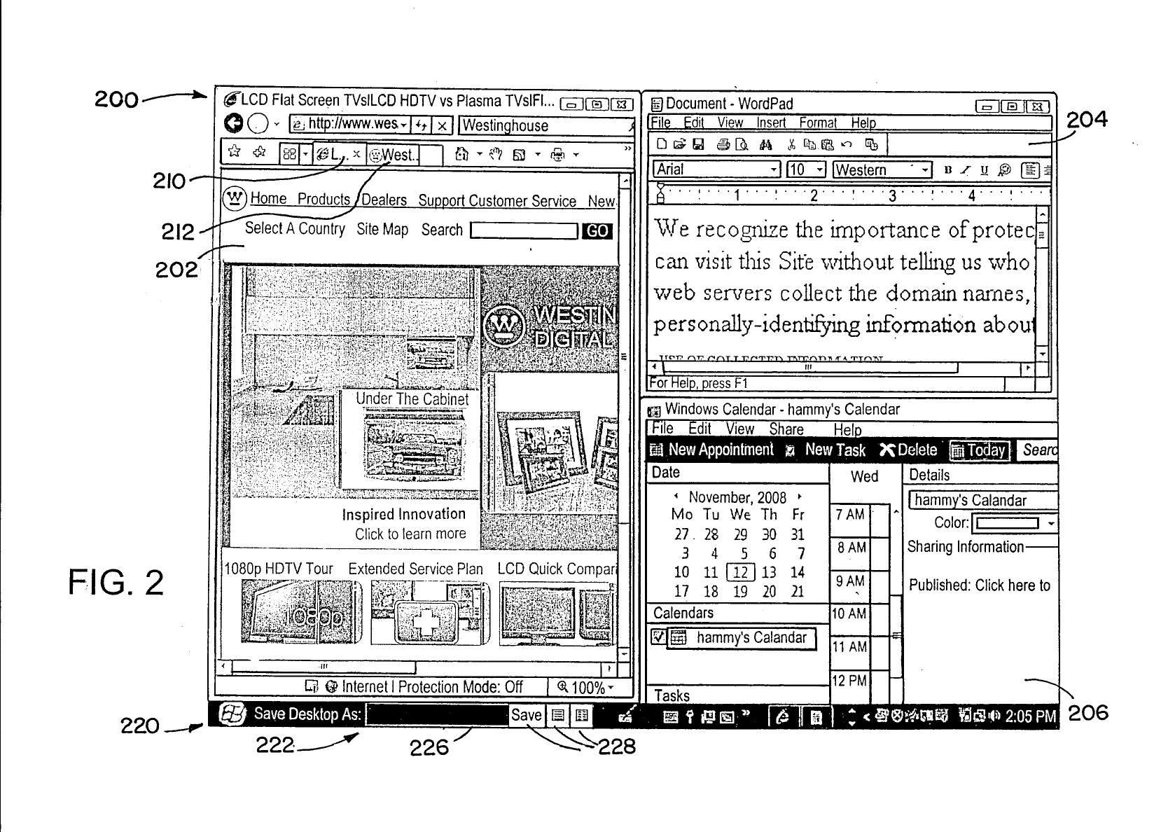

FIG. 2 shows a desktop 200 shown on a monitor or display (such as the monitor 191), for example using a WINDOWS XP operating system. The desktop 200 shows windows or panes 202, 204, and 206, with different programs open in a tile configuration. The window 202 shows a browser for navigating the world wide web. An example of such a browser is MICROSOFT INTERNET EXPLORER. The window 202 has a pair of tabs 210 and 212 for accessing different web sites, without having to navigate off of a site open in either tab.

The window 204 shows a word processing program, with a document open in the program. WORDPAD and MICROSOFT WORD are examples of well-known word processing programs.

The window 206 shows a calendar program for keeping track of appointments or the like. It will be appreciated that many suitable calendar programs are available. The calendar program is shown as open to a specific calendar or list of appointments.

The windows or panes 202, 204, and 206 are shown as tiled in the desktop 200, with boundaries of the windows 202, 204, and 206 not overlapping. The boundaries of adjacent of the windows 202, 204, and 206 may contact each other, and may fill substantially all of the display space of the desktop 200, except for a task bar 220.

The windows 202, 204, and 206 shown in desktop 200 are arranged with the windows 202 covering a left half of an active area of the desktop 200, with the windows 204 and 206 vertically tiled in the right half of the active area of the desktop 200. It will be appreciated that many other tiled arrangements are possible for the windows 202, 204, and 206.

Further, it will be appreciated that arrangements other than a tiled arrangement are possible for the windows 202, 204, and 206. For example there may be space between the boundaries of the windows 202, 204, and 206. Alternatively or in addition, there may be some overlap between the windows 202, 204, and 206. One example of an overlapping configuration is a cascading arrangement, where windows partially overlap one another, with for example an active window brought to the foreground, partially obscuring other of the windows. It will be appreciated that there may be a greater or lesser number of windows than is shown in FIG. 2. The windows may be in any of a wide variety of arrangements, with different features, such as with different documents open in them and/or different tabs for accessing different documents (or web sites) or other program features.

The task bar 220 may include a desktop-save-and-retrieval tool 222 for saving and retrieving desktop configurations (layouts). The tool 222 allows the user to save one or more desktop configurations (display layouts), for later use. The tool 222 includes a text box 226 for a user to enter a name or other alphanumeric identifier for identifying a display layout or desktop layout to be saved. The identifier may be an identifier that describes a function or use for the layout, such as “My Work,” “Multimedia,” or “Leisure.” Buttons 228 may be used for saving desktop layouts or for accessing previously saved layouts. The buttons 228 may function in any of a variety of ways, for example using pull down menus showing identifiers of recently selected desktop layout, showing one or menus allowing a user to select a desktop layout, and/or showing pictorial representations (thumbnails) of layouts.

The information saved regarding a desktop layout, to be possibly retrieved later, includes such information as the size and position of windows, and documents or web sites open within the programs running in the windows (the population of the windows or panes of the layout), settings within the programs run in the windows (such as the opening screen or active tab to be displayed within the windows), and settings regarding which of the windows are active (initially subject to keyboard and other commands input by the user) and/or which windows overlap other windows.

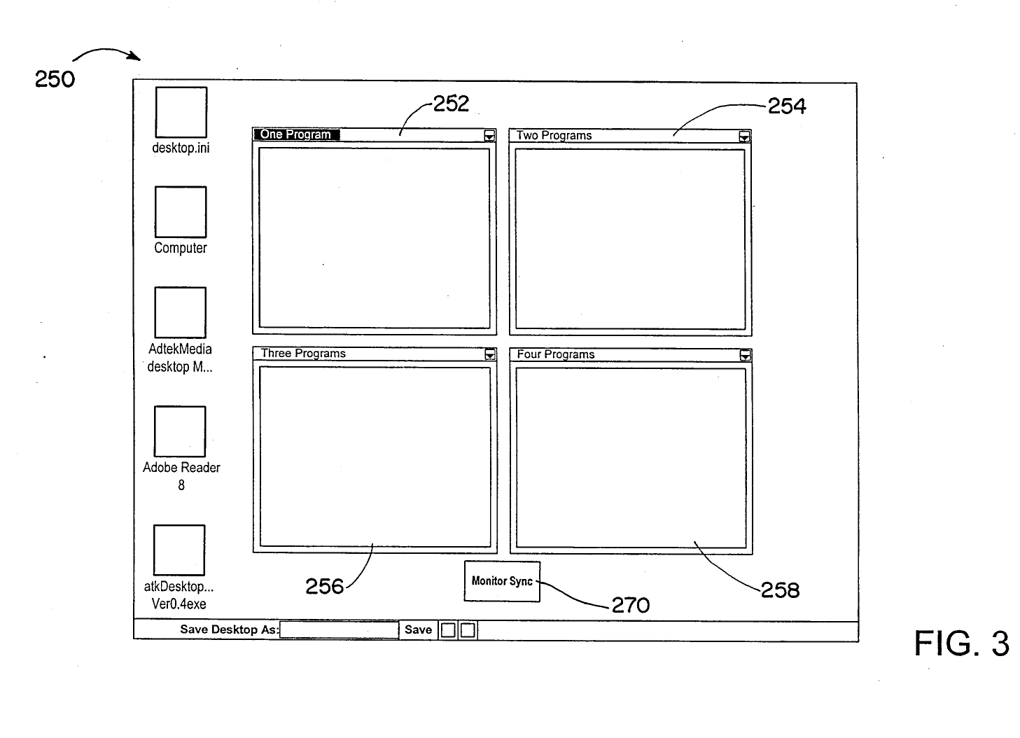

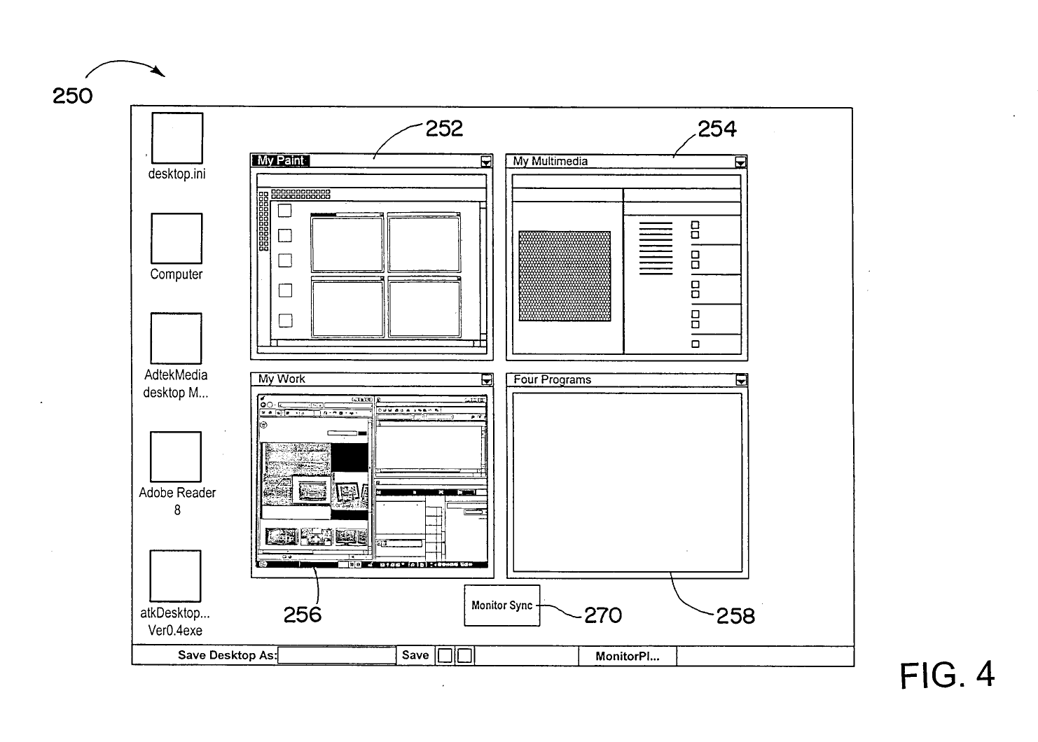

FIGS. 3 and 4 show one embodiment of a screen for populating desktop layouts, and/or for retrieving desktop layouts. FIG. 3 shows sample templates (possible layout arrangements) 250 that include a single window layout template 252, a two-window layout template 254, a three-window layout template 256, and a four-window layout template 258. The layout templates 252-258 may be populated by a user, for example by selecting programs from a list of programs or other content items. The list may be made available by a suitable operation, such as by selection from a menu of possible programs (or other content items) being called up clicking within a window or pane of a template that is to be populated. Another click of a menu item may be used to select a program to be placed in that window. When a program is selected for populating a window in one of the layout templates 252-258, a visual indication may be provided in the screen display. For example the program name or a graphic display of the program may be shown in the window, indicating to the user which windows are populated, and which programs populate them. The graphic or pictorial display may be any of a variety of graphic elements, such as an icon or a screen shot or other representation of how the program would actually appear in the window in question. The screen shot may be a thumbnail image of the actual appearance of the corresponding desktop layout when opened.

Names or other alphanumeric identifiers may be provided for the layout templates 252-258 by inputting them in a title bar, such as the title bar 262 of the layout 252. The title bars may also have drop down menus for selecting, displaying, and perhaps repopulating (modifying) other layout configurations.

FIG. 4 shows the templates 252, 254, and 256 populated. The screen as shown can be used to select a display layout to be displayed on the monitor. The populated templates 252, 254, and 256 may function as thumbnail images for selecting the layouts corresponding to the populated image templates shown. Selection of one of the thumbnails, such as by clicking on that thumbnail, may cause the system to call forth the operating system object that is the corresponding layout.

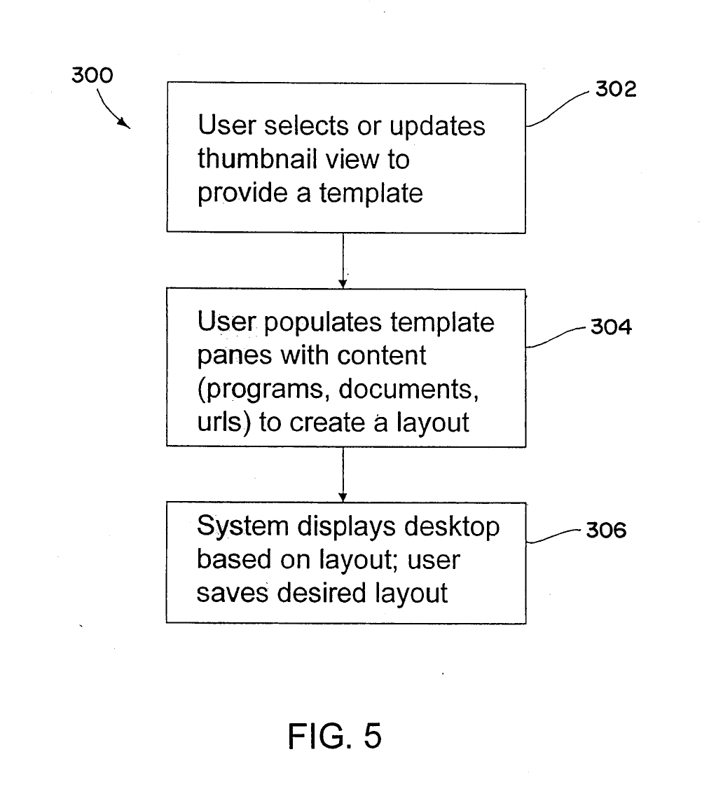

FIG. 5 is a high-level flow chart of one embodiment method 300 of forming and using the layouts. In step 302 a user selects or updates a thumbnail view to provide a template to be populated (or to be repopulated). In step 304 the user populates the windows or panes of the template, to create a layout. Finally, in step 306 the system 110 displays a desktop based on the user-populated template (layout), with the user able to save the corresponding layout so as to make the layout available for future use, to call up the corresponding desktop. The user (perhaps after modifying the desktop and thereby modifying the layout) then saves the layout.

During a later session the user can open the saved layout, which will load the chosen programs, documents and/or urls in the same windows configuration as originally defined by panes of the template created in step 302. In some cases, when opening a layout in a new session, the content of a window will be in the exact same state as stored by the user in a prior session, e.g. for a user document. Alternatively, the content may be in a “current version” state, e.g. such as the current version of a web page for a favorite url. As described below, the invention makes use of a novel template screen that can show both templates and layouts in thumbnail views, so that the user can design layouts using preexisting or newly designed templates. The same template screen (a.k.a. thumbnail view) can display layout thumbnails representing desktops saved in prior sessions, providing a convenient way to identify and open such desktops.

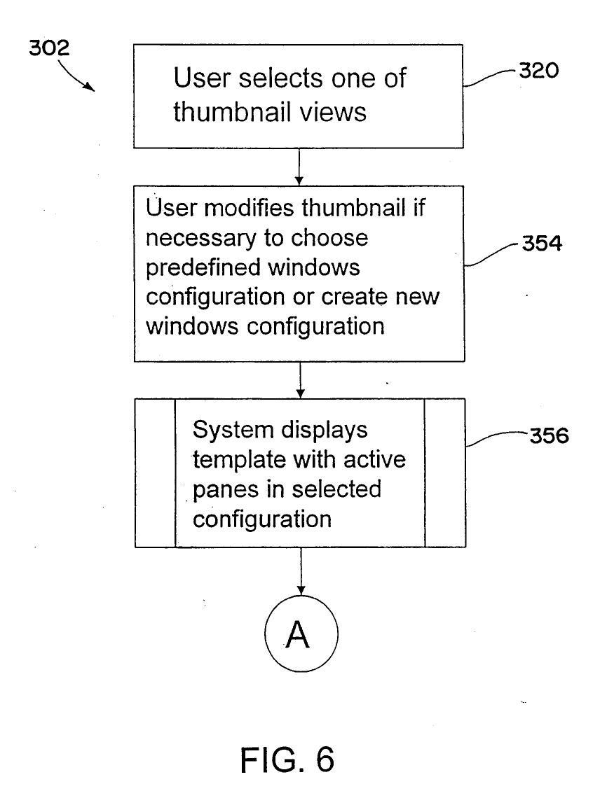

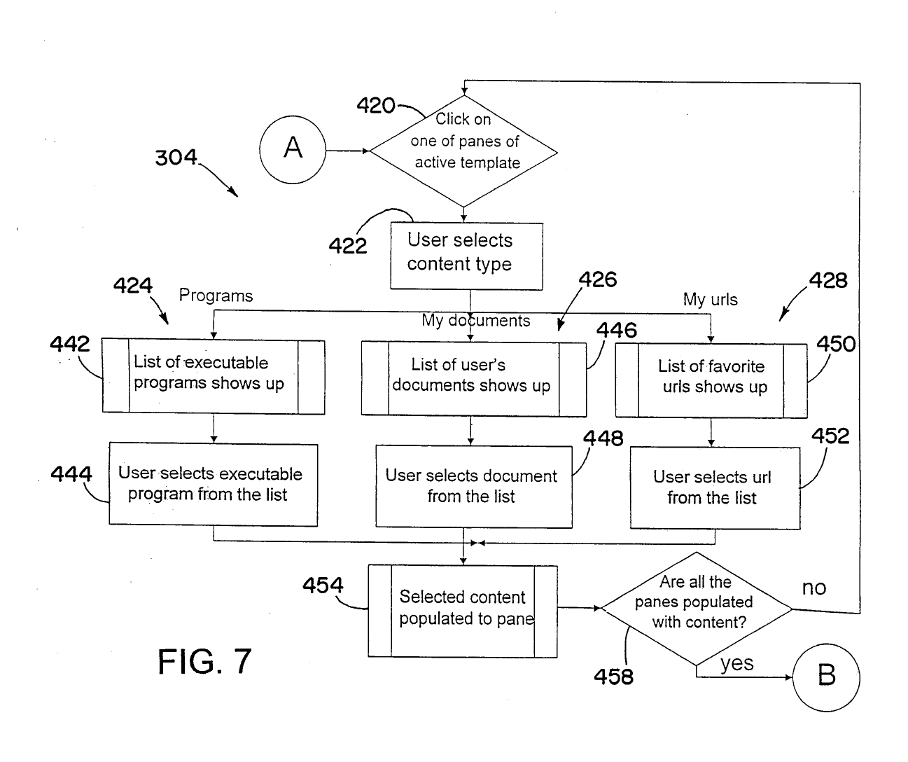

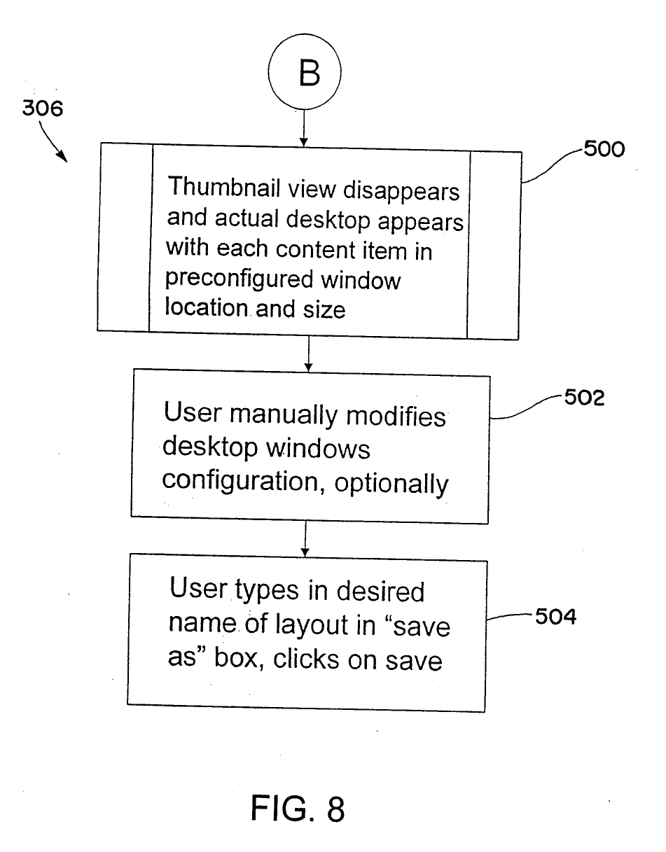

FIGS. 6-8 show more detail regarding the high-level steps described with regard to FIG. 5. FIG. 6 shows a layout creation method corresponding to step 302 in the template-based layout creation method of FIG. 5. FIG. 7 shows detail regarding the template populating step 304 of the method of FIG. 5. FIG. 8 shows further detail regarding the display step 306 of FIG. 5.

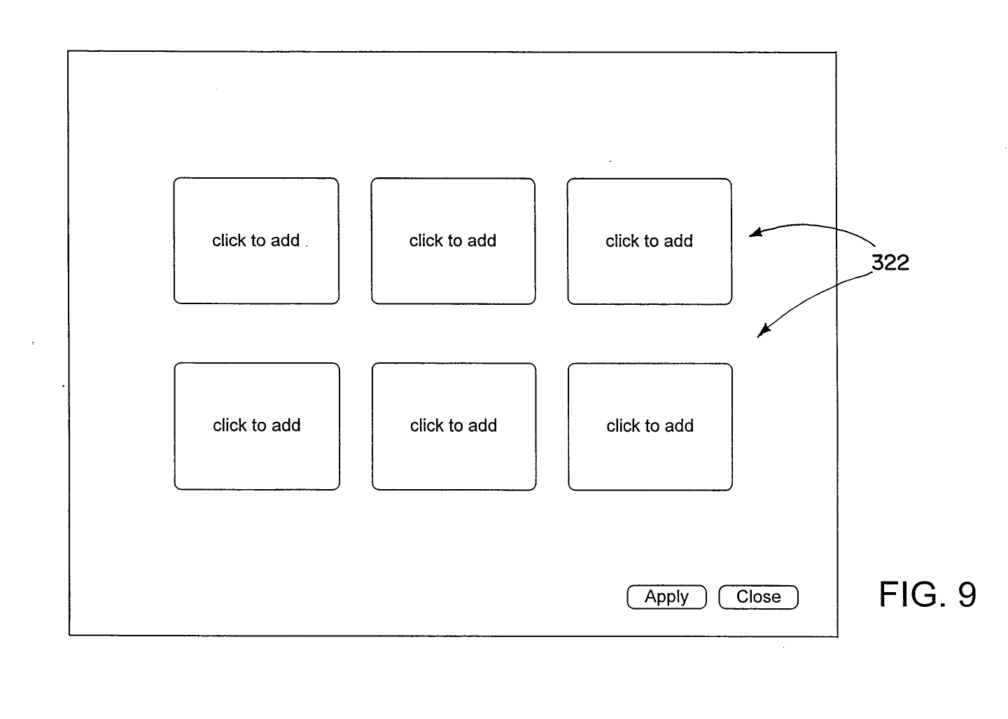

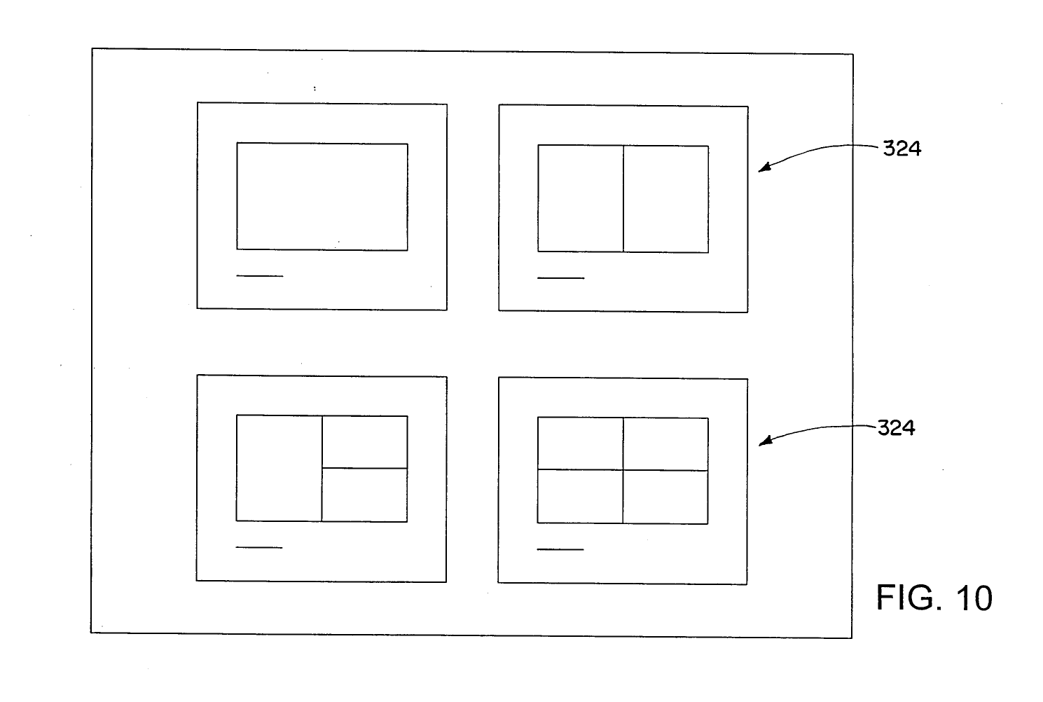

Referring to FIG. 6, in step 320 the user selects one of the thumbnail views. FIG. 9 shows a basic embodiment of a thumbnail view containing six blank thumbnails 322 that can be used to create templates, and layouts using the templates. For example, the user may click on one of the thumbnails 322 to bring up a menu of predesigned templates, i.e. configurations of windows or panes within the border of the thumbnail, and to select a desired template. FIG. 10 shows a thumbnail view showing four template configuration thumbnails 324, respectively having one, two, three and four tiled panes that are associated with respective individual thumbnail template configurations 324.

Typical thumbnail views include 2×2, 2×3 and larger arrays. These thumbnail views may incorporate dynamic arrays, i.e. arrays that can change based upon factors such as a user's most frequently selected templates and layouts.

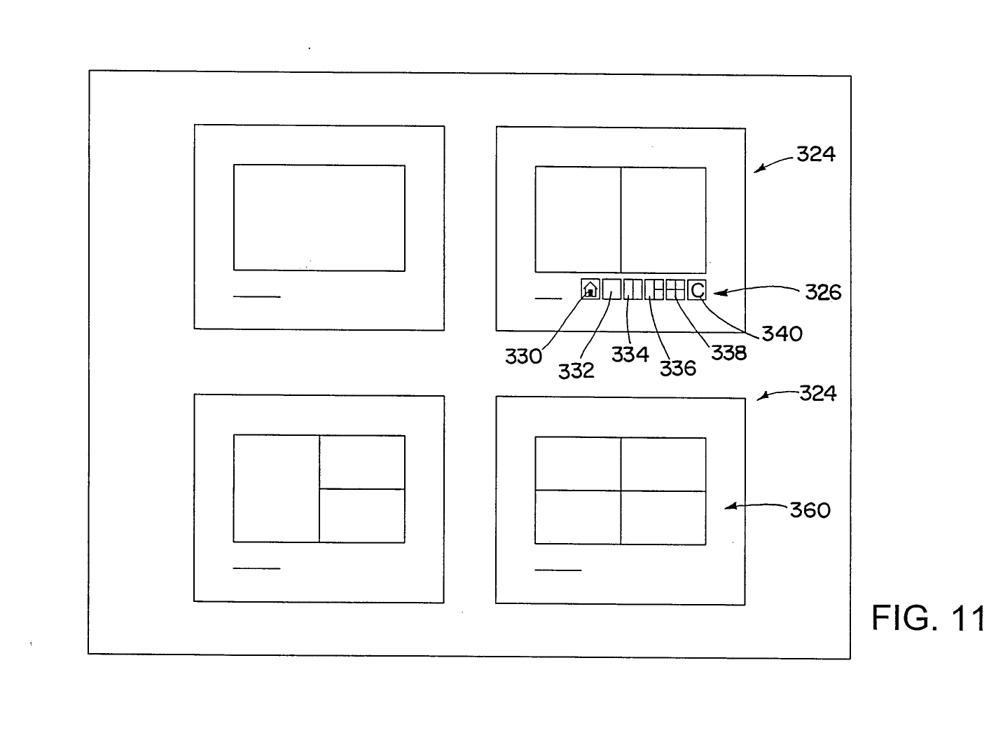

FIG. 11 shows a variant of the view of FIG. 10, where one of the thumbnail template configurations 324 has the additional element of a control bar 326 shown below one of the templates. The control bar 326 may be configured to appear when the user hovers or clicks a mouse cursor in the region below one of the thumbnails 322. The control bar 326 permits the user to change the existing template configuration at that thumbnail into one of the alternate template configurations of one, two, three, or four panes. In addition, the control bar 326 may permit the user to select a template that is different than the four default configurations, or to design a new template.

The control elements of one embodiment of the control bar 326 include the elements 330-340. The element 330 retrieves the last saved template or layout configuration associated with that thumbnail. In one embodiment, non-volatile memory associated with each thumbnail location stores the last saved template or layout, overwriting any prior template or layout associated with that thumbnail. Alternatively, the system may store multiple templates or layouts in association with a given thumbnail. In this case the control bar would display and retrieve any prior stored templates or layouts.

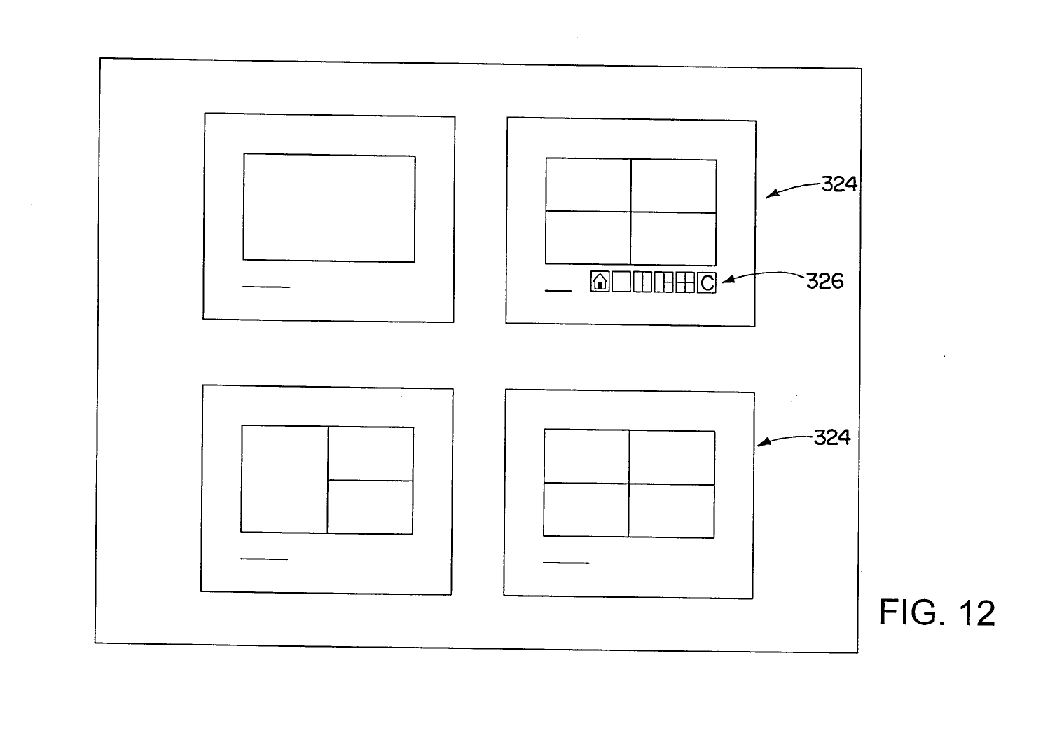

The control bar elements 332, 334, 336, and 338 of control bar 326 respectively retrieve the default one, two, three and four-pane template configurations, which can represent popular windows configurations programmed into the system. Thus for example, in FIG. 12 the user has selected the four-pane configuration to replace the two-pane default configuration for that thumbnail shown in FIG. 11. The element 340 permits the user to choose previously designed templates besides the default templates, and to design new templates, as discussed below with reference to the template design tool.

Referring back now to FIG. 6, in step 354 the user modifies the thumbnail if necessary by choosing a previously designed windows configuration (i.e. the panes of a template) or by designing a new configuration. Thus for example the user may simply select one of the templates 322 of FIG. 10 and use that template without modification. Alternatively, the user may bring up the control bar 326 (FIG. 11) and use the control bar 326 to select an alternative template or to design a new template. In step 356 the system displays the template at the chosen thumbnail, with active panes arrayed in the selected configuration.

To illustrate a template with active panes, refer to the lower-right thumbnail 360 in FIG. 11. When the thumbnail 360 has been selected by the user, each of the four panes acts as a separate zone or area of pixels that may be activated by mouse-over movement or by clicking the mouse or pointing device within that zone. This permits the user to select each of the panes in sequence in the method for populating the template with content items, as discussed below with reference to FIG. 7.

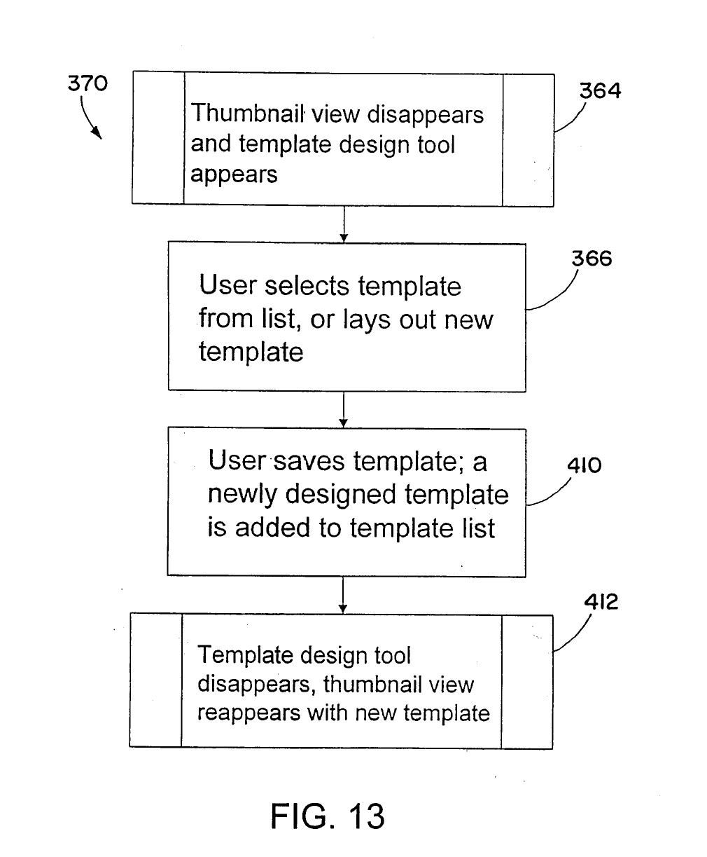

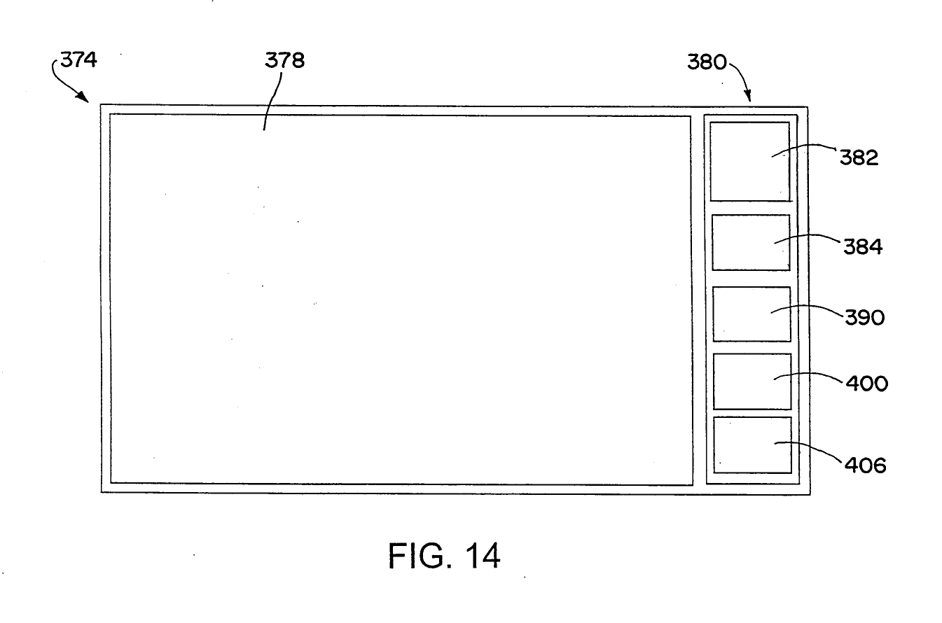

FIG. 13 is a flow chart of steps regarding use of a template design tool that may be selected and populated with other steps of the method 300 of FIG. 5. The template design tool may be activated by selecting the element 340 of the control bar 326 (FIG. 11), as indicated in step 364 of the template design method 370. FIG. 14 is a schematic view of a template design tool 374 that would be displayed on screen when the user selects the “C” (“custom”) button (the element 340) in the control bar 326, in performing step 364. The template design tool 374 includes a display area 378 that displays templates being designed using the tool 374, and a control area 380 that provides various modules for design and retrieval of templates. Typically the display area 378 is larger than a thumbnail but smaller than the full desktop. Module 382 of the template design tool 374 retrieves a list of previously designed templates and permits the user to select a template other than the templates that are accessible via the thumbnail view and default options in the control bar. This forms one possible operation of a step 366 of the method 370, a step that more broadly involves selecting a template, or laying out a new template.

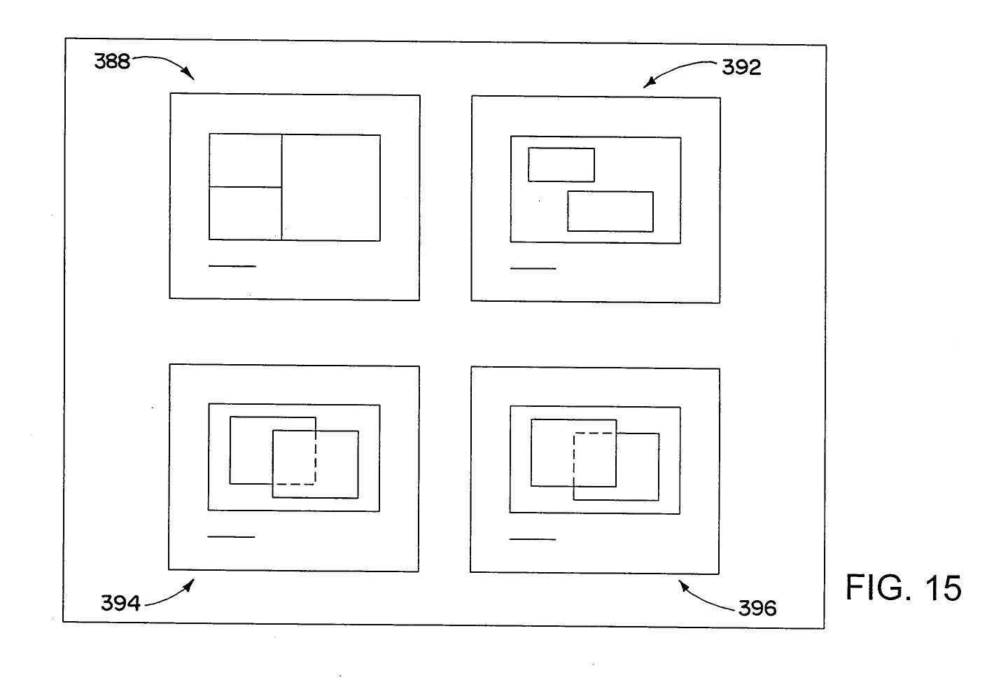

Another possibility in the step 366 is the user laying out a new template. Toward this end the design tool 374 includes a module 384 that activates a border drawing tool that is used for designing templates with tiled (abutting) panes. The border drawing module/tool 384 can draw vertical and horizontal lines that may extend entirely or partially across the length and width of the display area. Thus for example referring to the upper-left template 388 of FIG. 15, the border drawing tool 384 may be used to create a three-pane, asymmetric tiled layout.

The design module 390 of the template design tool 374 is a rectangle drawing tool that can be used to design templates with windows that are not tiled. An example is shown in the upper right template 392 of FIG. 15, where the rectangle drawing tool 390 has been used to create two non-overlapping, non-abutting panes. In the lower templates 394 and 396 of FIG. 15, the rectangle drawing tool was used to create two overlapping panes (cascade windows). In this event, the system 110 (FIG. 1) may query the user as to which pane should be in the foreground, and templates 394 and 396 show the alternative pane configurations that can be selected using the rectangle drawing tool module 390.

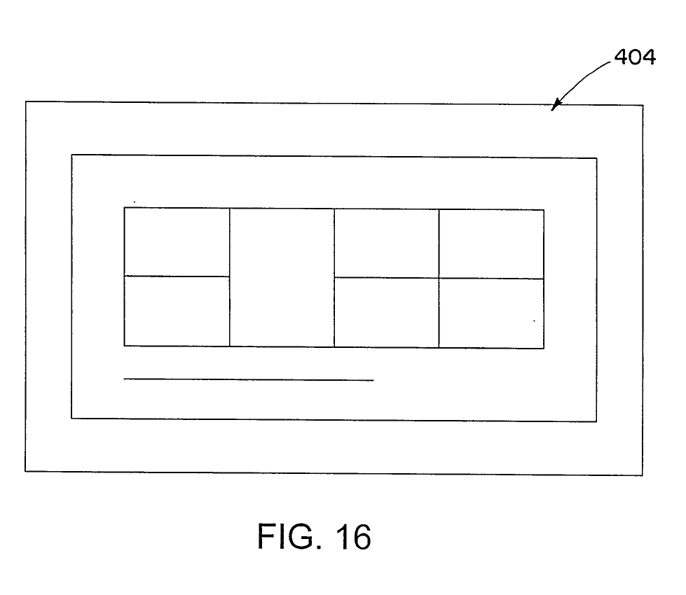

Module 400 is a specialized design module of the template design tool 374 that can be used, for example, to design templates to create layouts corresponding to desktops that are intended for display on two or more monitors. For example, the user can indicate a template for a two monitor, side-by-side desktop configuration. This would change the aspect ratio of the design window, by increasing (e.g. doubling) the width relative to the height. FIG. 16 shows an example of a two-monitor template 404 resulting from use of the design module 400. It will be appreciated that other configurations are possible, including doubling the height of the monitors by stacking one monitor on top of another, changing aspect ratios of monitors for example by turning a monitor on its side (such as in a portrait mode, which may be useful for viewing web pages and long text documents, for example), combining different sizes and/or aspect ratios of monitors, and/or by combining more than two monitors.

Module 406 of the template design tool 374 is a utility module that is used to save newly designed templates, which then are added to the template list accessible via the module 384. Upon saving a template in step 410 of the method 370 (FIG. 13), in step 412 the design tool 374 disappears and the system reverts to the thumbnail view, for example displaying the new template with active panes. The utility module 406 also permits a user to modify the configuration of a template designed with other modules of the tool, e.g. by dragging and dropping a border, or relocating an entire window.

FIG. 7 shows details of a preferred method for populating each of the panes of a selected template with content items, which corresponds to the template populating step 304 in the template-based layout creation method 300 of FIG. 5. As shown by flow marker A, the process sequence of FIG. 7 continues from the process of FIG. 6. At step 420 the user selects one of the panes of the interactive template resulting from the method of FIG. 6. At step 422 the user then selects the type of content item (content type) he wishes to populate into the selected pane. In the illustrated embodiment, there are three types of content items: programs, selected by a process 424; documents, selected by a process 426; and web sites (urls), selected by a process 428. The user may select the content type from a menu, by selecting among multiple lists, or in some other fashion.

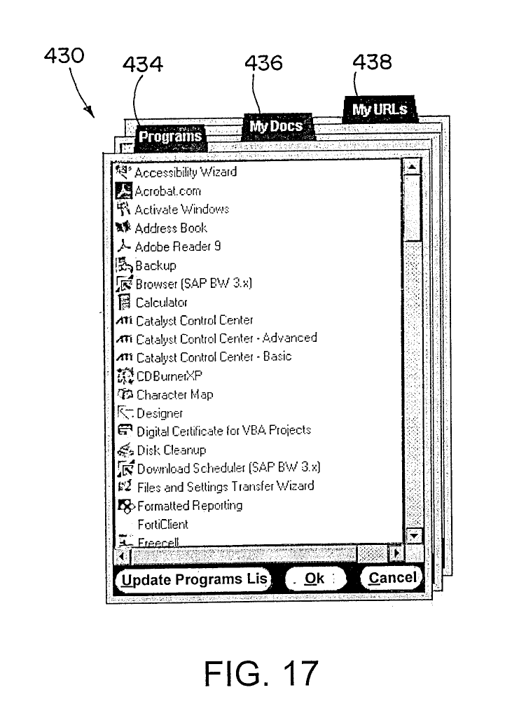

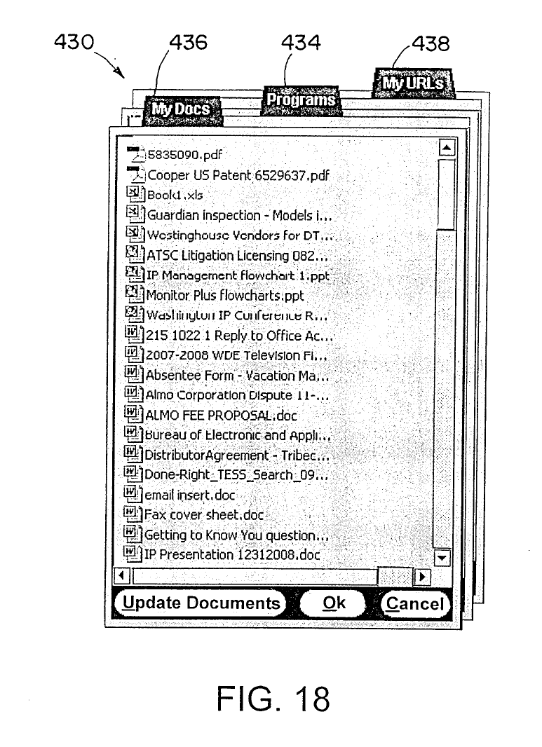

FIGS. 17 and 18 show one type of user interface that enables a user to select a content type, then select a particular content item of this type, to populate into a selected template pane. FIGS. 17 and 18 show different views of a list tool 430 that includes three different lists, a “Programs” list 434, a “My Docs” list 436, and a “My URLs” list 438, as identified by header tabs. To select a particular content type, the user clicks on the desired header tab, which moves the corresponding list to the foreground. Thus in FIG. 17 the programs list 434 is displayed, each program item being identified by a program logo and program name. In FIG. 18 the documents list 436 is displayed, each user document being identified by the document type (shown by the logo for the program used to create the document) and the document name.

Referring again to FIG. 7, after the user selects a content type, the process flow proceeds along the appropriate branch for that content type. In the Programs branch 424, a list 434 of executable programs (FIG. 17) shows up in step 442, and in step 444 the user selects an executable program from the list 434. In the My Documents branch 426, in step 446 a list 436 of the user's documents (FIG. 18) shows up, and the user selects a document from the list in step 448. In the My urls branch 428, a list 438 of the user's favorite urls shows up in step 450, and the user selects a url from the list in step 452. The selected content item is populated into the active template pane in step 454. In step 458 the system checks whether all panes of the template have been populated with content items. If not, the system waits for the user to select another pane. If the user has populated all template panes with content, this completes creation of the layout at flow point B.

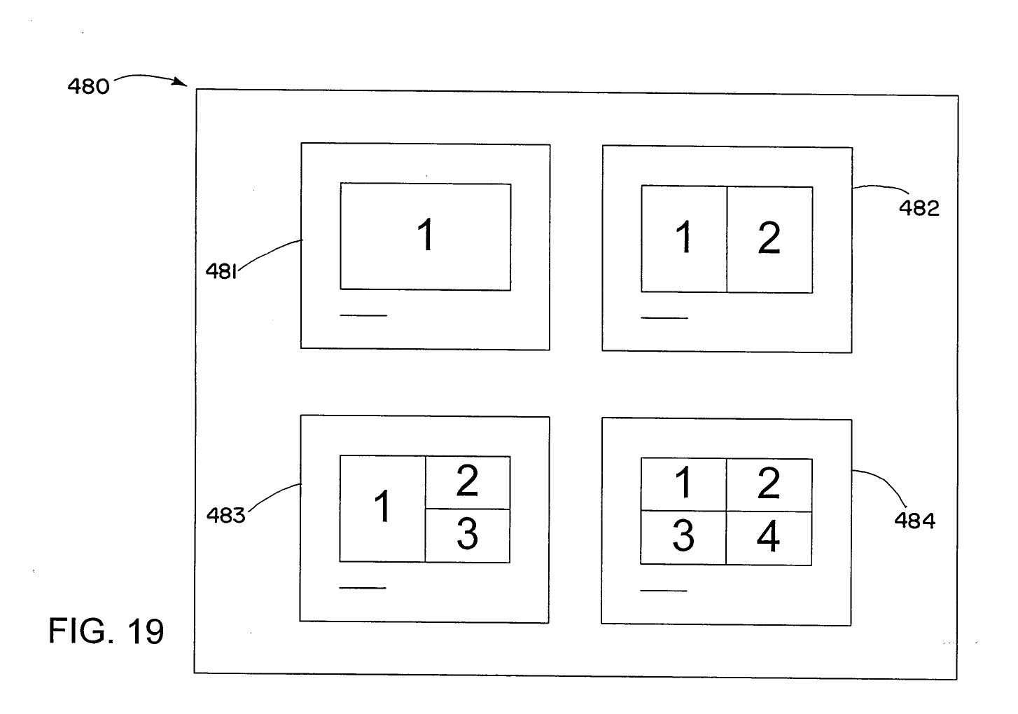

An alternative template arrangement 480 is shown in FIG. 19. Each template thumbnail 481, 482, 483, and 484 is responsive to a pointing device, but the panes within the thumbnails 481-484 are not separately interactive with a pointing device. The panes contain numerals (1, 2, 3 and 4, as appropriate to the number of panes) in order to inform the user of the sequence with which the template panes are populated with content in an alternative to the layout-creation method 304 of FIG. 7. Thus for example in populating the panes of the three-pane template 483, first pane 1 receives content, then pane 2 and finally pane 3, without the user clicking these individual panes. The process of presenting content lists to the user to permit the user to select content to each of the panes can be the same as discussed above for FIG. 7 and this process would be repeated until each pane has been assigned content.

FIG. 8 shows the process sequence corresponding to the step 306 in FIG. 5. Once the user completes creation of a layout at flow point B from FIG. 7, in step 500 the system opens a full screen desktop view corresponding to that layout. As part of the step 500, the system detects the resolution of the monitor, and scales up the panes of the template to a configuration of windows of the same relative locations and sizes. At step 502, the user can manually modify the configuration of the layout, such as by moving borders between panes. Thus the user can reduce the size of a layout that occupies the entire desktop to a window that occupies only part of the desktop, or can provide non-tiled pane configurations such as overlapping panes or panes with separation between borders. At step 504, the user saves the Layout for use in a later session, e.g. using the “Save As” function in the Microsoft WINDOWS operating system.

A consideration is the representation of programs, documents, and urls within a layout, so that a thumbnail view of a layout helps the user remember or recall the stored content and retrieve the desired layout for use in a later session. This representation can be created at step 504 of the process sequence shown FIG. 8. One approach is for the layout's thumbnail view to use a scaled down graphic based upon a screen capture of the full desktop. Alternatively, icons and/or text can be used to identify content items within a layout. In the case of programs, an application icon can be used. In the case of documents, a document file name or other user-assigned name can be used. For urls, a domain name, or web site name or logo can be used. It will be appreciated that these are only examples, and that other sorts of representations, icons, graphics, text, or combinations thereof, may be used. Normally these graphical or textual representations of stored content would be assigned by the system subject to possible user preferences. In addition, the user can name the entire layout for ease of retrieval.

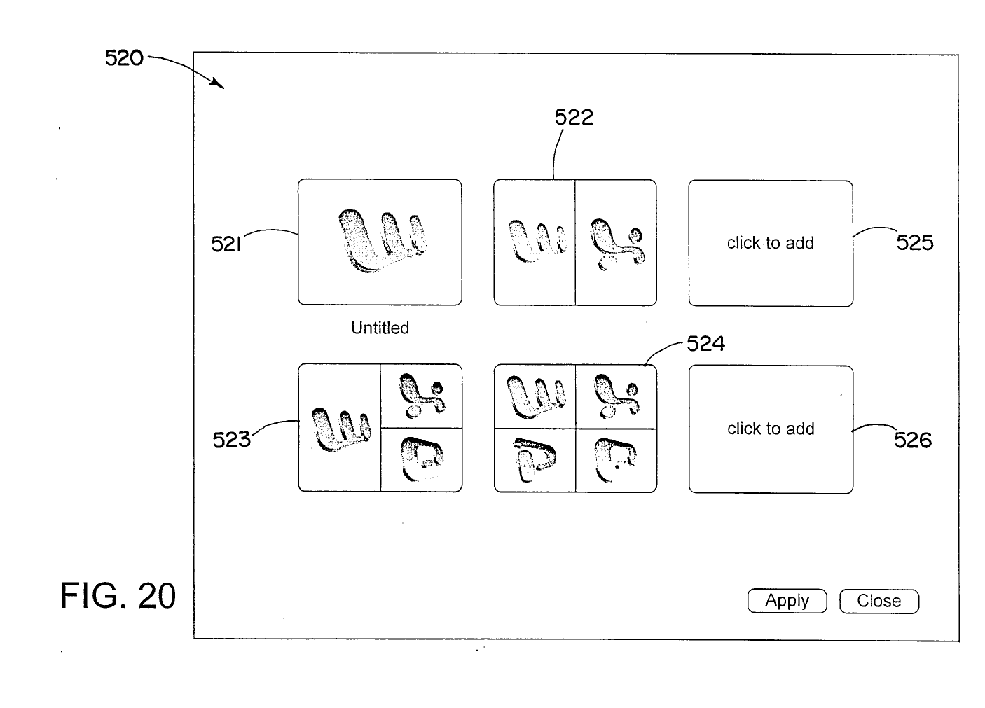

FIG. 20 is a thumbnail view 520 of four layouts 521, 522, 523, and 524, respectively for one, two, three and four-window desktops. The layouts represented by the thumbnails 521-524 shown in this view are all of the type that launches executable different programs in each pane of the desktop. These executable programs are represented by application icons. It will be appreciated that other icons may be used for other types of content items. A pair of empty-space thumbnails 525 and 526 can be selected, such as by clicking, in order to select and populate templates, or to select already-saved layouts to show in the thumbnail view 520.

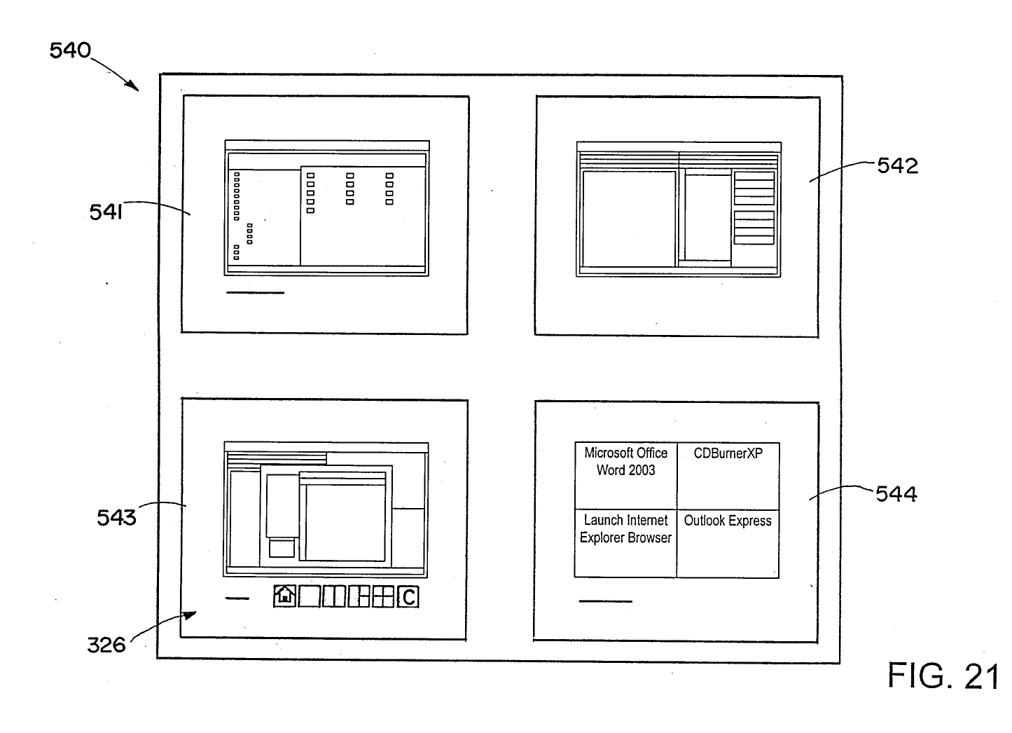

FIG. 21 is a thumbnail view 540 of four layouts 541, 542, 543, and 544 again based on one, two, three and four-pane configurations. The one-pane, two-pane, and three-pane layouts 541-543 are all based upon screen captures of the desktops that were saved following the creating of the layouts using the methods of FIGS. 7 and 8. The two-pane layout 542 shows two program views in a tiled configuration. The three-pane layout 543 is also a screen shot, but shows cascaded windows rather than tiled windows, which were produced by manipulating the windows after opening the desktop but before saving the desktop. The four-pane layout represents executable programs using program names. Although the typical practice would to use a uniform format to represent program items (such as all icons, in FIG. 20), it will be appreciated that mixed formats, such as shown in the view 540, may instead be used.

The user may be able to mix templates and layouts on the same menu screen, and to convert a layout thumbnail back to a template thumbnail in order to create a new layout. In the latter case, the user would click below a layout thumbnail to bring up the control bar of FIG. 11 and would choose one of the default or custom template options of the control bar in order to replace the layout with a desired template. Thus in FIG. 21, the control bar 326 is shown below the three-pane layout at lower left, and the user can click on the tiled three pane template 543 in order to replace the cascade layout with a tiled template in preparation for creating a new layout in one of the default (tiled) formats.

When starting a new session the user may choose a desired desktop configuration from a thumbnail view of previously saved layouts. Alternatively the system may select a default desktop configuration during startup. For example, the system may detect EDID or EEDID information of a single monitor or multiple monitors and may choose a default template associated with the monitor identification information, as further discussed below.

A monitor syncing (MonitorSync™) function can also be activated by selecting (as by double clicking) a monitor sync button or icon 270 (FIGS. 3 and 4) of the display. This activates a monitor sync function that allows configuring of multiple screens or monitors that are attached to the computer system 110 (FIG. 1).

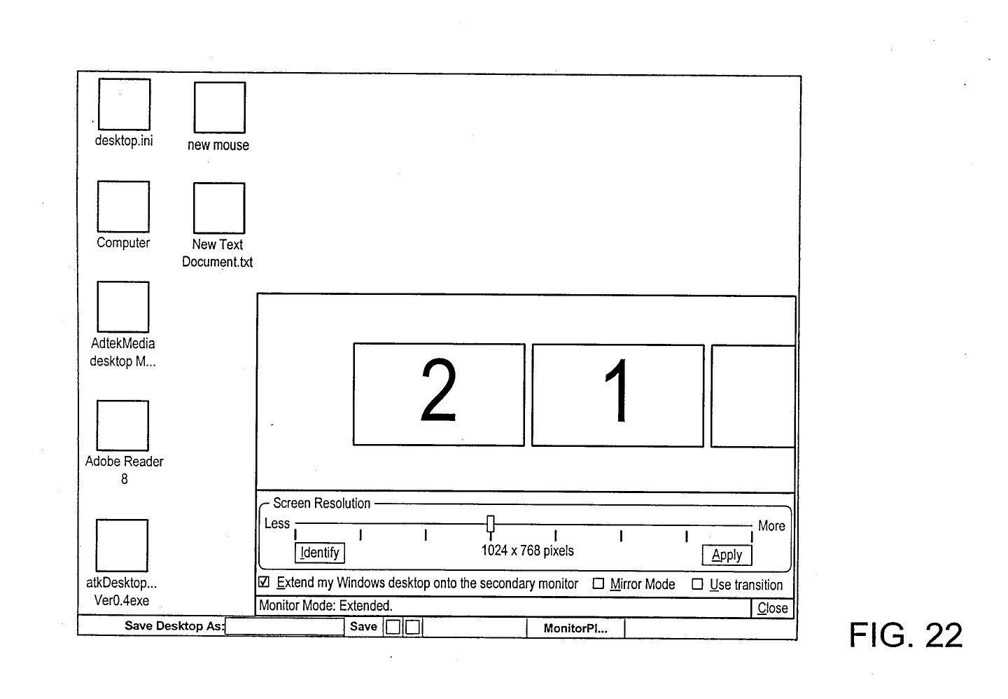

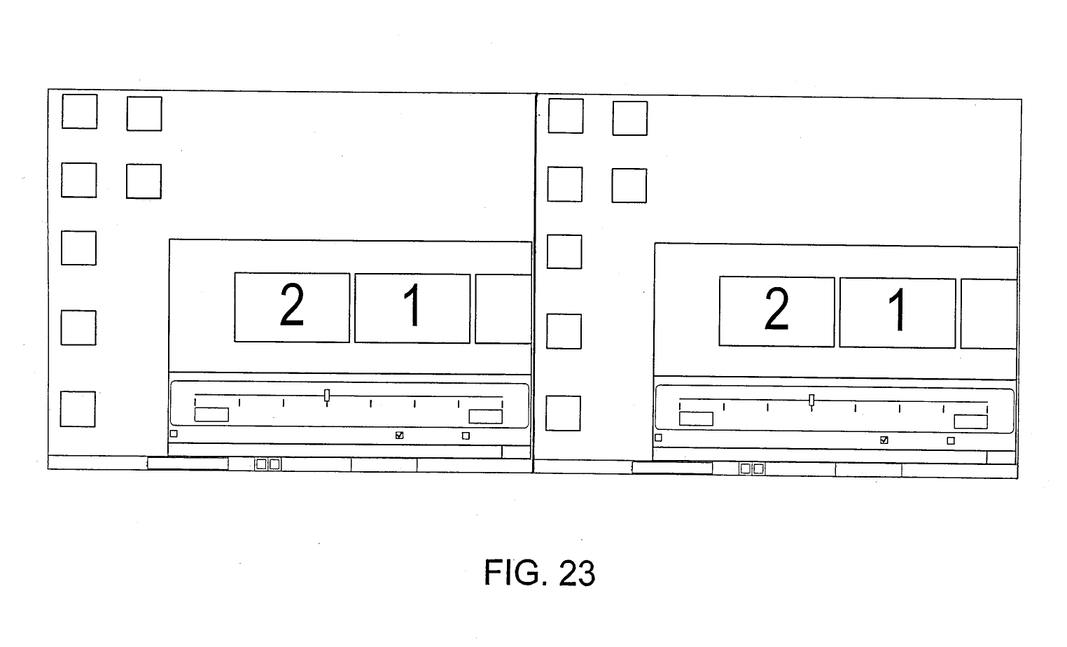

With reference now in addition to FIGS. 22 and 23, operation of an embodiment of the monitor sync function is now described. The monitor sync function provides many advantages, including the ability to provide display layout configurations to different monitors that may be attached to the computer system, or may be part of the computer system. Examples of external monitors that may be attached to a computer system include large-screen televisions or monitors, such as plasma screen monitors, light emitting diode (LED) monitors, and digital light processing (DLP) monitors. Another type of monitor is a projection display, which may be used for displaying material from a computer onto a screen, such as for viewing by a large audience. Also notebook computers are often connected to a larger or clearer monitor when used at a fixed work station, such as at an office desk or at a home office. Such connections may be made directly from the external monitor to the notebook or other portable computer, or may be made via a docking station that the portable computer is coupled to. A further instance where external monitors are coupled to a computer is when additional monitor space is desirable to display more information or have more programs available than can comfortably be fit onto a single monitor screen. Such situations arise in a large number of situations, for example in software development (where multiple windows are used for running and editing programs) and in financial trading (where it may be desirable to keep tabs in real time on many prices and other pieces of data, while perhaps also following news developments).

Activating the monitor sync function, such as by pressing the button or icon 270 (FIGS. 3 and 4), calls forth the monitor selection/configuration feature shown in FIGS. 22 and 23. The monitor selection feature uses an extended monitor function to create various multi-monitor display effects. One example of the display effects is the mirror mode shown in FIG. 23. The mirror mode allows the same image to be displayed on two or more monitors/displays that are a part of and/or connected to the computer system. For example the mirror mode allows display of the same image on both the display of a notebook or laptop computer, and an external monitor or display, such as a large-screen display or projector, that is coupled to the notebook or laptop computer. The mirror function may be activated by selecting a check box, for example using a mouse or other pointing device. Alternatively the monitor function may be selected using a wide variety of other mechanisms, for instance using other mechanisms commonly used in graphical user interfaces.

Besides mirroring, the monitor selection/configuration feature may be capable of performing other functions, for example configuring multiple displays/monitors to act as a single display/monitor, for example with a cursor able to be positioned on one or the other of the monitors/displays. The multiple monitors/displays may act as a single monitor/display displaying respective parts of the same desktop. For example items may be able to be dragged from one monitor/display view to another monitor/display view. A pointing device such as a mouse or trackball may be used to select or otherwise manipulate items on difference screens.

Another possible user feature is that the user may be able to set the screen resolution of the display. A button may allow the user to identify a preferred or appropriate screen resolution.

It should be appreciated that the multi-monitor functions described above may be performed in software. The user does not have to remember hardware-based switches such as hotkeys or function keys.

The computer system 110 (FIG. 1) may also be able to associate individual monitors with configurations to be used with those monitors or displays. The display may be configured automatically upon detection of connection to a monitor for which a display configuration has previously been selected and/or assigned. The computer system 110 may recognize monitors by identification information associate with a monitor, identification information that may be communicated as part of communication in an extended display identification data (EDID) format or an enhanced extended display identification data (EEDID) format.

The computer system 110 may use software to reconfigure the desktop to a saved state based on the configuration associated with the monitor configuration (which monitor(s) is/are present as part of or attached to the computer system 110). The reconfiguration may be automatic, or may be done only after receiving confirmation from a user.

Other factors may also be included in the display configuration process. Different display configurations or populated templates may be selected for different times of day. The computer system 110 may make a selection of a display configuration based in whole or in part on additional factors. For example the time of day may be used as a selection criterion or factor, as an alternative to or in addition to use of a configuration previously associated with the present monitor configuration.

The software may also be configured to make a determination of the display configuration for the monitor based on information provided by an external monitor, even if the external monitor has never been previously connected to the computer system 110. Information communicated from an external monitor or display during the connection process (such as EEDID information) may be used by the computer system 110. For example the EEDID or other monitor information may contain information regarding a resolution of the monitor. This may allow the size of the monitor or display to be inferred, which may in turn allow an interference of the purpose for use of the additional monitor or display. The system 110 may select a display configuration by use of this information (perhaps in conjunction with other information).

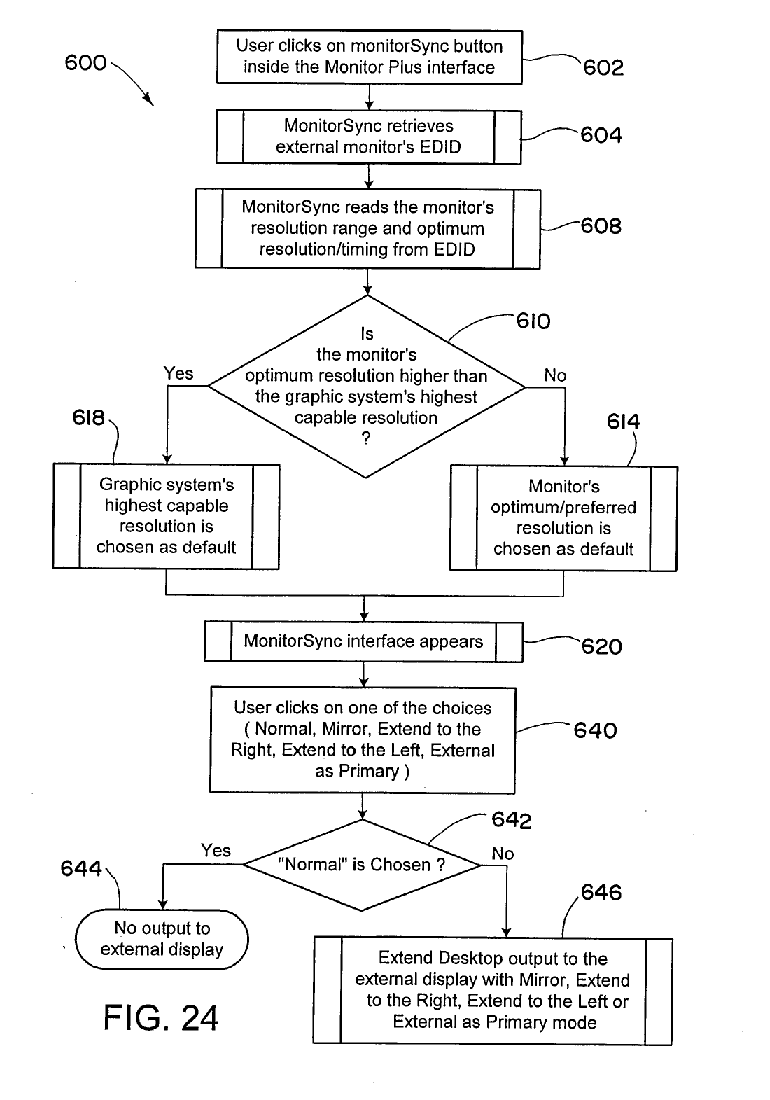

Referring now to FIG. 24, a high-level flow chart is shown of a method 600 for carrying out the monitor sync function. In step 602 the user activates the monitor sync function, such as by clicking on the button or icon 270 (FIGS. 3 and 4) in a suitable interface. Then in step 604 the computer system 110 retrieves the EDID or EEDID from an external monitor that is coupled to the computer system 110. Information regarding the external monitor, such as the monitor's resolution range and optimum resolution/timing, is retrieved from the EDID (or EEDID) in step 608.

In step 610 different courses of action are followed depending on whether the external monitor's optimum/preferred resolution is higher than the highest capable resolution of the graphics system of the computer system 110. If the graphics system is capable of handling the external monitor's optimum/preferred resolution, then that optimum/preferred resolution is set as the default resolution, in step 614. However, if the graphics system of the computer 110 is not capable of handling the external monitor's optimum/preferred resolution, then in step 618 the graphic system's highest capable resolution is set as the default for handling the external monitor.

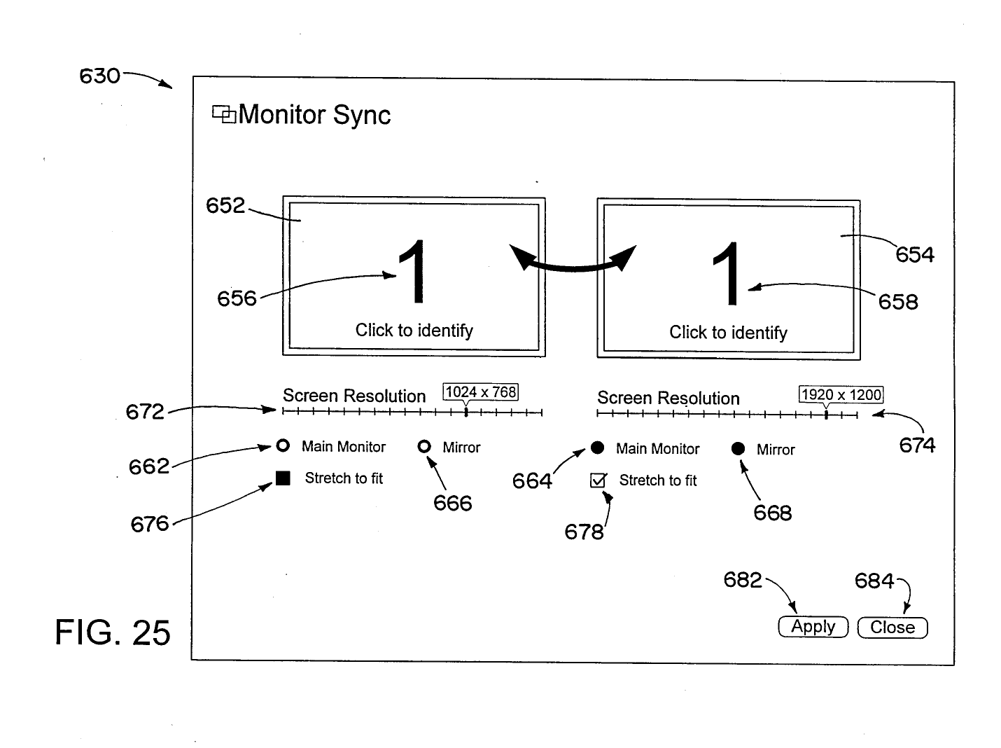

In step 620 a monitor sync interface appears on the monitor 191 of the computer system 110 (FIG. 1). The monitor sync interface is a graphical user interface controlled by a user that allows the user to interactively control what is displayed on multiple monitors, for example including a main monitor 191 that is part of the computer system 110, and an external monitor that is coupled to the system 110. FIGS. 25-28 show various views of a monitor sync interface 630, representing various configurations selected by the user in step 640 of the method 600 (FIG. 24). In a “normal” configuration of the monitor sync interface, there is no output to the external monitor (external display), as indicated at steps 642 and 644 of the method 600. On the other hand, if other configurations of the monitor sync interface have been selected, either by the user or by default, then external desktop output is sent to the external monitor in step 646.

The monitor sync interface 630 includes representations 652 and 654 of a pair of monitors, with respective numerical indicators 656 and 658 in the representations 652 and 654. The numerical indicators 656 and 658 indicate the location of the primary monitor, and whether both of the corresponding monitors are showing the same display, or alternatively are showing different displays. The numerals “1” and “2” indicate different views on the corresponding monitors when both numerals are shown. In addition, when both numerals are present, the numeral “1” indicates the relative location of the main monitor (e.g., the monitor permanently, originally, or primarily attached as part of the computer system 110 (FIG. 1)), and the location relative to that of the external or secondary monitor is indicated by the numeral “2”. When both numerals are the same, the monitors are in a mirrored configuration, with the view on the secondary monitor the same as that on the main monitor. Also, when both numerals are the same, both numerals being “1” may be used to indicate that the primary (main) monitor is the monitor on the left (corresponding to the representation 652 in the interface 630), and both numerals being “2” may be used to indicate that the primary (main) monitor is the monitor on the right (corresponding to the representation 654 in the interface 630). In normal operation when the monitors are in mirror configuration, the secondary monitor will adopt the resolution of the main monitor.

The interface 630 may have main monitor buttons 662 and 664 used to indicate which of the representations 652 and 654 is to correspond to the main monitor of the computer system 110. Also, mirror buttons 666 and 668 may be selected by the user to invoke mirror of the displays on the two monitors (main and external).

Further, the interface 630 may include screen resolution tools 672 and 674 to set the resolution of the monitors corresponding to the representations 652 and 654. The tools 672 and 674 are shown as slider bars, but it will be appreciated that the tools 672 and 674 may take any of a variety of other forms.

The interface 630 may include check boxes 676 and 678 that indicate that the respective monitors corresponding to the representations 652 and 654 are to be stretched to fit their corresponding monitors. This may allow the corresponding monitors to stretch their displays to fill all of the monitors, regardless of the screen resolution indicated in the screen resolution tools 672 and 674. This may allow for mirroring of monitors with different aspect ratios, or more broadly for use of all display space of the monitors.

The monitor sync interface 630 includes an apply button 682, used to apply the present settings set by the other controls of the monitor sync interface 630. The interface 630 also includes a closure button 684 that may be used to apply the present settings and close the interface 630.

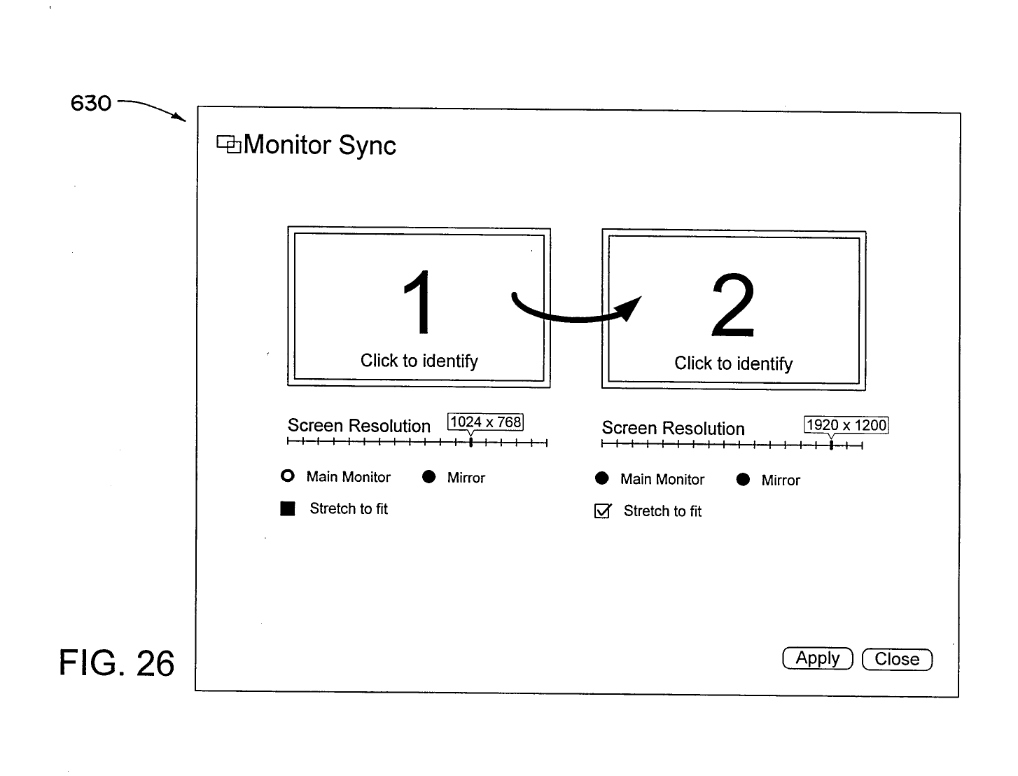

Referring now to FIGS. 25-28, various monitor sync configurations of the monitor sync interface 630 shown therein will now be described. FIG. 25 shows a configuration in which the monitors are mirrored, with the main monitor located to the left of the external or secondary monitor. FIG. 26 shows a version where the main monitor is to the left of the external or secondary monitor, with the monitors showing different content. The different content may correspond to an extended display template, such as the multi-monitor template 404 shown in FIG. 16.

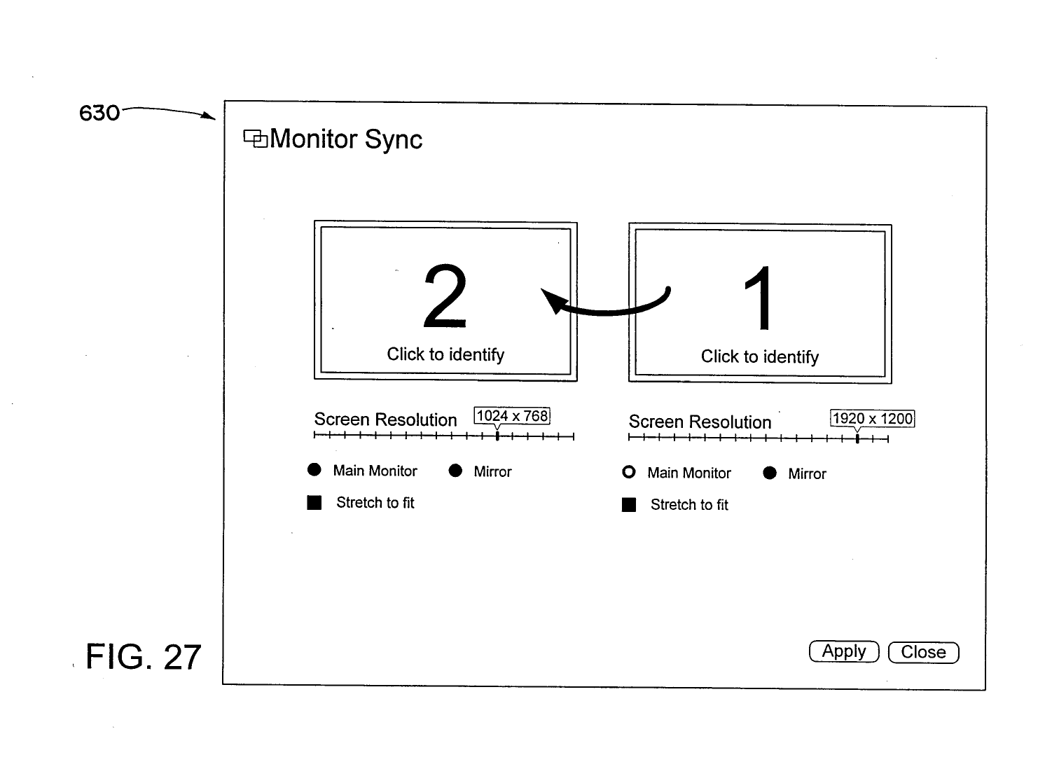

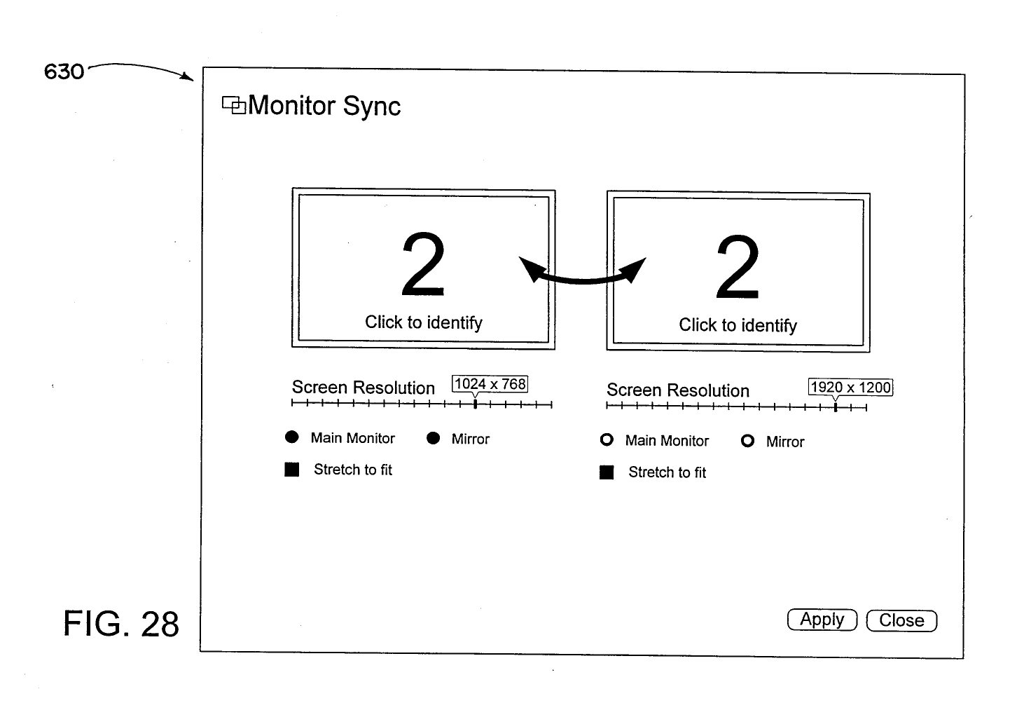

FIG. 27 shows a similar situation to that of FIG. 26, but in this case with the main monitor to the right of the secondary or external monitor. The monitors show different content, perhaps differently-sized windows with different content items, perhaps at different resolutions. FIG. 28 shows another mirrored configuration, but this time with the main monitor in the rightmost position.

The interface 630 has the advantage of allowing a user to clearly and intuitively make choices regarding options for displaying content on multiple monitors. It will be appreciated that mastering arcane and particularized monitor configuration procedures may involve a level of study and commitment beyond that desired by many users, and that the interface 630 thus may provide an advantage over present interface systems.

It will be appreciated that many variations are possible for the monitor sync interface 630. To give one example, the interface 630 may be configured to provide an option for a “normal” view, in which content is only displayed on a single monitor, such as the main or primary monitor. As another alternative, the interface 630 may be configured to allow selection of an external monitor as the primary monitor, for example providing the external monitor with the content from the multi-monitor template 404 (FIG. 16) that is intended for the primary or principal monitor.

Another possible variation is that the interface 630 may be configured to handle other configurations of dual monitors, such as a top/bottom configuration instead of or in addition to the left/right configuration. Still another possibility is configurations involving three or more monitors.

A further possible variation is that the computer system 110 may associate certain layouts or graphics settings with individual monitors, combinations of monitors, and/or types of monitors, and may call forth layouts or default graphics settings that have been or are associated with the individual monitors, combinations of monitors, and/or types of monitors. Individual monitors may be recognized based on EDID or EEDID tags. The EDID data, including particularly the manufacturer name and serial number, and the product type, can be used to select display configurations that can be based on the type of monitor device, and based on recognition of individual monitors. An example is a default desktop configuration or Layout for multiple monitors based on the serial numbers of those monitors. In addition, EDID data can be employed together with other system data (such as time of day) as parameters for user-customized display configurations.

Although the invention(s) has (have) been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of generating user-customized display configurations in a computer system, the method comprising:
selecting, by a user, of one or more templates from a plurality of templates; and
receiving user input to populate at least one of the templates with one or more content items, to thereby create one or more layouts that may be used to create one or more desktops.

2. The method of claim 1, wherein the one or more content items include selection by the user from one or more programs, one or more documents, and one or more urls.

3. The method of claim 1, wherein the templates each have one or more interactive panes that are separately activatable by the user to initiate population of an individual pane with a content item.

4. The method of claim 1, wherein the templates each have one or more panes; and
wherein the templates are each activatable as a whole to initiate populating of the one or more panes of that template.

5. The method of claim 1, further comprising creating new template configurations by the user.

6. The method of claim 1, further comprising, following the receiving the user inputs, saving the one or more layouts corresponding to the one or more populated user templates.

7. The method of claim 1, wherein the at least one of the templates includes a template that corresponds to a desktop that extends across multiple monitors of the computer system.

8. A method of displaying a layout on a computer system, the method comprising:
saving one or more user-configured display layouts, wherein the display layouts each include one or more panes associated with respective content items to be loaded in the one or more panes;
automatically selecting one of the user-configured layouts; and
displaying, on a display of the computer system (or attached to the computer system), a desktop associated with the selected display layout.

9. The method of claim 8, wherein the automatically selecting includes selecting based on characteristics of a display that is connected to the computer system.

10. The method of claim 8, further comprising, when a display connected to the computer system, associating one of the user-configured display layouts with the display.

11. The method of claim 10, wherein the associating includes receiving a user input indicating the one of the user-configured display layouts to be associated with the display.

12. A method of generating user-customized display configurations in a computer system, the method comprising:
displaying a plurality of thumbnail images on a computer screen, wherein the thumbnail images represent templates and/or layouts; and
allowing user selection of one of the thumbnail images to perform a computer operation related to the template or layout associated with the selected one of the thumbnail images.

13. The method of claim 12, further comprising, when a thumbnail image associated with a template is selected, allowing user population of the template by associating a content item with each pane of the template, to thereby produce a corresponding layout.

14. The method of claim 13, wherein the templates each have one or more interactive panes that are separately activatable by the user to initiate population of an individual pane with a content item.

15. The method of claim 13,
wherein the templates each have one or more panes; and
wherein the templates are each activatable as a whole to initiate populating of the one or more panes of that template.

16. The method of claim 13, wherein the one or more content items include selection by the user from one or more programs, one or more documents, and one or more urls.

17. The method of claim 13, wherein the allowing user population includes altering a template that corresponds to an existing layout that is saved in the computer system.

18. The method of claim 12, further comprising permitting a user to select a template from a plurality of possible template configurations, to associate with one of the thumbnails.

19. The method of claim 18, wherein the selected template is associated with a thumbnail previously associated with another template.

20. The method of claim 12, wherein the selected template is associated with a thumbnail previously associated with a layout.

21. The method of claim 20, further comprising the user configuring a template, wherein the configuration includes customizing the number and location of panes within the template.

22. The method of claim 12, further comprising, when a thumbnail image associated with a layout is selected, displaying a desktop based on the layout.

23. The method of claim 12, wherein at least some of the thumbnails include logos representing content items of layouts.

24. The method of claim 12, wherein at least some of the thumbnails include text representing content items of layouts.
